(19) United States
(12) Patent Application Publication
(10) Pub. No.: US 2026/0219456 A1
(43) Pub. Date: Jul. 30, 2026

(54) OPTICAL DEVICE WITH SUBSTRATE AND INDEX-MATCHED COUPLER FIELD

(71) Applicant: Phosio Corporation, Corvallis, OR (US)

(72) Inventors: Nan-Chieh Chiu, Corvallis, OR (US); Douglas A. Keszler, Corvallis, OR (US); Omid Sadeghi, Corvallis, OR (US)

(21) Appl. No.: 19/459,611

(22) Filed: Jan. 26, 2026

Related U.S. Application Data
(60) Provisional application No. 63/749,691, filed on Jan. 26, 2025.

(51) Int. Cl. G02B 6/34

(52) U.S. Cl. CPC G02B 6/34

(57) ABSTRACT

Examples are disclosed that relate to forming gratings on waveguides. One example provides a method of fabricating an optical grating. The method comprises applying a precursor solution onto a substrate, the precursor solution comprising a metal-ligand complex, to form a precursor solution film, and removing at least some solvent from the precursor solution film to form a metal oxy-hydroxy with a first refractive index. The method further comprises forming a patterned mask layer on the metal oxy-hydroxy film, and transferring a pattern of the patterned mask layer to the metal oxy-hydroxy film by dry etching to form a patterned metal oxy-hydroxy film. The method further comprises exposing the patterned metal oxy-hydroxy film to one or more of ultraviolet light or heat to form a patterned metal oxide film with a second refractive index that is closer to a refractive index of the substrate than the first refractive index.

This application claims priority to U.S. Provisional Patent Application No. 63/749,691, filed January 26, 2025, the entirety of which is hereby incorporated herein by reference.

### BACKGROUND

Many optical devices use transparent waveguides to conduct light by total internal reflection. Grating structures can be used to couple light into and/or out of a waveguide, and/or to condition light within a waveguide, by diffraction. Such grating structures can be patterned and fabricated by lithographic processes.

### SUMMARY

Examples are disclosed that relate to forming gratings on waveguides, wherein the gratings are index-matched with the waveguides. One example provides a method of fabricating an optical grating. The method comprises applying a precursor solution onto a substrate, the precursor solution comprising a metal-ligand complex, to form a precursor solution film, and removing at least some solvent and ligand from the precursor solution film to form a metal oxy-hydroxy with a first refractive index. The method further comprises forming a patterned mask layer on the metal oxy-hydroxy film, and transferring a pattern of the patterned mask layer to the metal oxy-hydroxy film by dry etching to form a patterned metal oxy-hydroxy film. The method further comprises exposing the patterned metal oxy-hydroxy film to one or more or more of ultraviolet light or heat to form a patterned metal oxide film with a second refractive index that is closer to a refractive index of the substrate than the first refractive index.

Another example provides an optical waveguide, comprising a substrate configured to support propagation of light within the substrate by total internal reflection, and an optical grating comprising a patterned metal oxide film on a side of the substrate, the optical grating configured to couple light into and/or out of the substrate.

Another example provides an optical waveguide comprising a substrate configured to support propagation of light within the substrate through total internal reflection; and an optical grating comprising a metal oxide deposited on a side of the inorganic substrate, the optical grating configured to couple light into and/or out of the substrate, the metal oxide having a refractive index of 2.0 or greater, an optical transmission of 90% or greater in the visible spectrum, and exhibits a haze of less than 0.1%.

### BRIEF DESCRIPTION OF THE FIGURES

FIGS. 1A-1B show a flow diagram illustrating an example method of forming a grating on a substrate.

FIGS. 2A-2B schematically show examples structures that can be formed in an implementation of the method of FIGS. 1A-1B.

FIG. 3 shows a dispersion curve of a 150-nm thick metal oxide film cured at 250 ºC for 15 minutes, demonstrating a refractive index of approximately 2.30 at λ = 550 nm.

FIG. 4 shows a dispersion curve of a UV-cured metal oxide film followed by a 100 ºC bake, demonstrating a refractive index of 2.16 at λ = 550 nm, with no absorption (k = 0).

FIG. 5 shows an optical transmission spectrum of a ~100 nm thick film with refractive index n = 2.30 deposited on high refractive index glass, demonstrating over 90% transmission and minimal absorption.

FIG. 6 shows a scanning electron microscopy (SEM) image of a grating structure fabricated from a metal oxide film, demonstrating well-defined features with high uniformity and smooth sidewalls.

### DETAILED DESCRIPTION

As mentioned above, diffractive gratings can be used to couple light into and/or out of a waveguide, and/or to condition light within a waveguide. Such gratings can be patterned and fabricated by lithographic processes. As one example, a waveguide can be patterned directly to form a grating in the substrate by sequential steps of hardmask and resist deposition, followed by photoexposure through a mask and resist development. The hardmask then can be etched to produce a patterned hardmask. The hardmask pattern is then transferred directly into the substrate through an additional etch process to produce the grating in the substrate. However, etch rates of some waveguide materials can be relatively slow, resulting in relatively higher fabrication costs.

Other optical devices may have a grating structure formed in a coating applied to the substrate. The coating can be patterned via initial sequential steps of resist deposition, resist radiation exposure, and resist development. The resist pattern can then be transferred to the coating via a gas etch or solvent development.

Forming a diffractive grating by patterning a layer on a waveguide may offer advantages over forming a diffractive grating directly in a waveguide. However, some challenges with patterning a layer on a waveguide exist. For example, the coating layer needs to have a suitably high refractive index (RI). However, current methods for depositing high RI materials, such as vapor deposition methods (e.g. atomic layer deposition (ALD)), can be expensive and time-consuming. Sol-gel methods, while potentially less costly than vapor deposition methods, can require relatively high processing temperatures (e.g. approximately 700 °C) that render them incompatible with heat-sensitive substrates. These high temperatures often result in undesirable effects, including substrate and film deformation, cracking, surface roughness, and/or optical haze, all of which adversely affect the performance and reliability of the final optical component. Further, high RI materials can have relatively slow etch rates. This can cause pattern transfer from a patterned mask layer by etching to be relatively slow, thereby increasing costs. Further, the coating also should have an RI that is matched with an RI of the substrate sufficiently to avoid perceptible reflections of light from the interface between the coating layer and the substrate.

Accordingly, examples are disclosed that relate to the formation of coatings that can be patterned to form diffractive gratings for waveguides and that address the problems described above. Briefly, the disclosed examples utilize metal oxide precursor solutions that allow for the formation of a relatively high-RI coating (e.g. RI above 2.0) using relatively low-temperature processing (e.g. 600 °C or lower). A precursor solution according to the present disclosure can be applied using efficient methods such as spin coating, dip coating, doctor blading, etc. After application, the precursor solution can be dried to form a metal oxy-hydroxy film with a first refractive index. The metal oxy-hydroxy film with the first refractive index then can be patterned by photolithography and dry etching (e.g. reactive ion etching (RIE)). After patterning, the metal oxy-hydroxy film can be cured to form a metal oxide film with a second refractive index higher than the first refractive index by exposing the metal oxide film to heat and/or ultraviolet (UV) light in a curing process. The second refractive index is more closely matched to a refractive index of the substrate than the first refractive index, thereby avoiding perceptible and/or light-wasting reflections at the grating/substrate interface.

The use of a precursor solution to form a metal oxide film can provide for a faster and lower cost deposition than forming a metal oxide film using a vapor deposition process, such as atomic layer deposition (ALD). Further, the metal oxy-hydroxy film before curing has a lower density than the metal oxide film after curing. Thus, an etch rate of the metal oxy-hydroxy film before curing is higher than an etch rate of the metal oxide film after curing, thus allowing for more efficient etching of the grating from the metal oxide film. The higher etch rate also may allow the metal oxy-hydroxy film to be patterned using a radiation-sensitive resist (e.g. a photoresist) as a mask, rather than a separately-patterned hardmask. In comparison, a metal oxide film formed by ALD has a higher density and a lower etch rate than the metal oxy-hydroxy film with the first refractive index (after solvent removal but before curing). As such, a metal oxide film formed by ALD may require more time to etch, and in some instances may require use of a hardmask that has to be separately patterned. Thus, by etching the metal oxy-hydroxy film before curing to form the metal oxide film, a grating can be formed more quickly and with less expense than the use of metal oxide film formed by vapor phase deposition.

The disclosed examples thus can provide for the fabrication of high-RI optical components under suitably low temperature conditions, allowing compatibility with a wide range of substrates while achieving enhanced optical and structural performance. The disclosed examples further may allow the production of components with atomic-scale smoothness, reduced optical haze, and precise dimensional control. The disclosed examples can be used for a wide variety of optical devices. For example, the disclosed examples can be used in augmented reality (AR) display systems to provide for superior image quality, more compact form factors, and reduced weight compared to other approaches for forming gratings on waveguides.

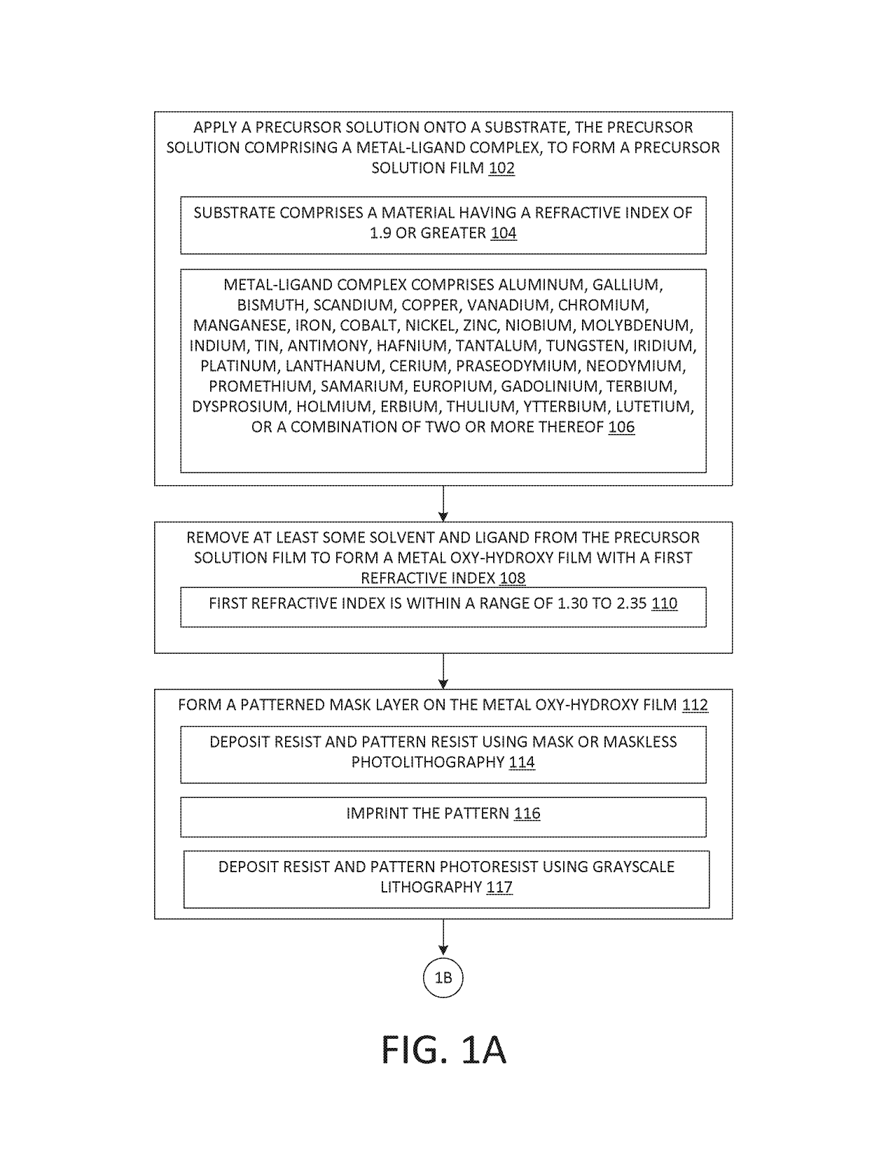

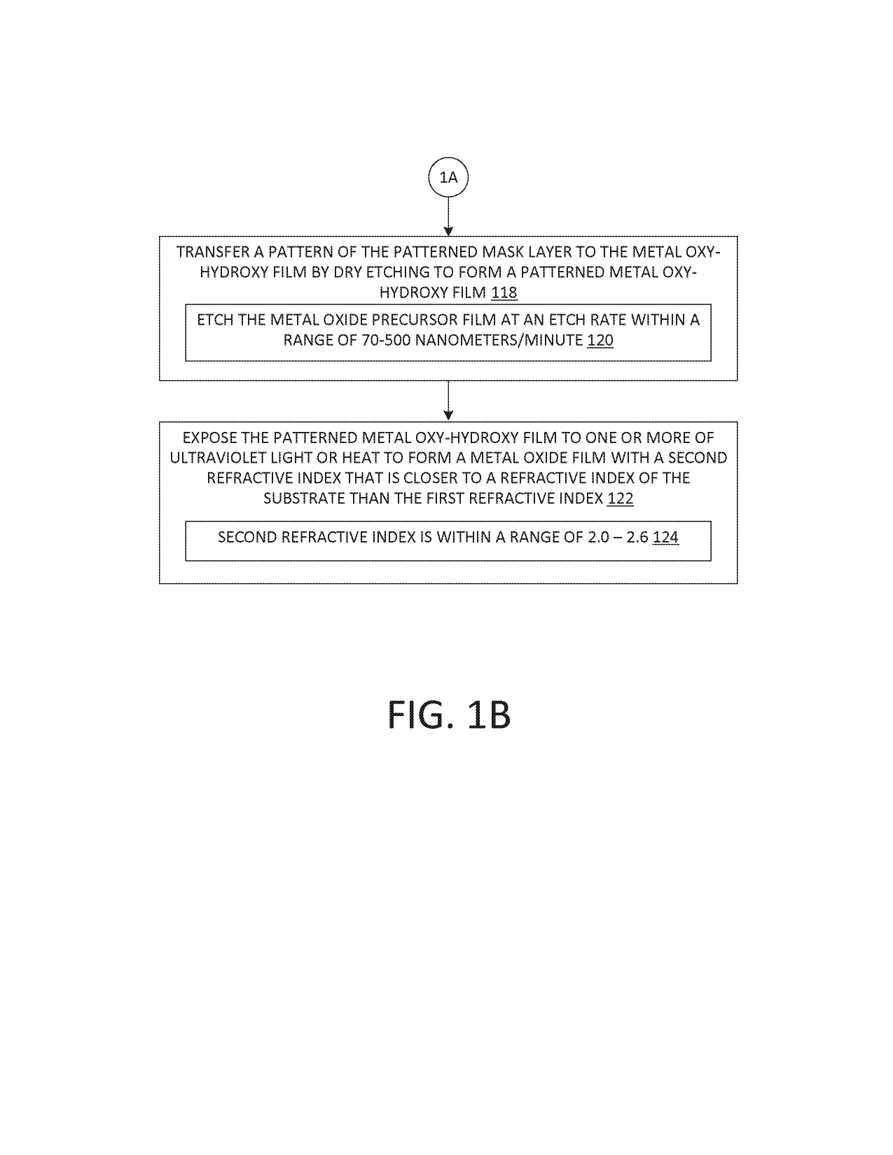

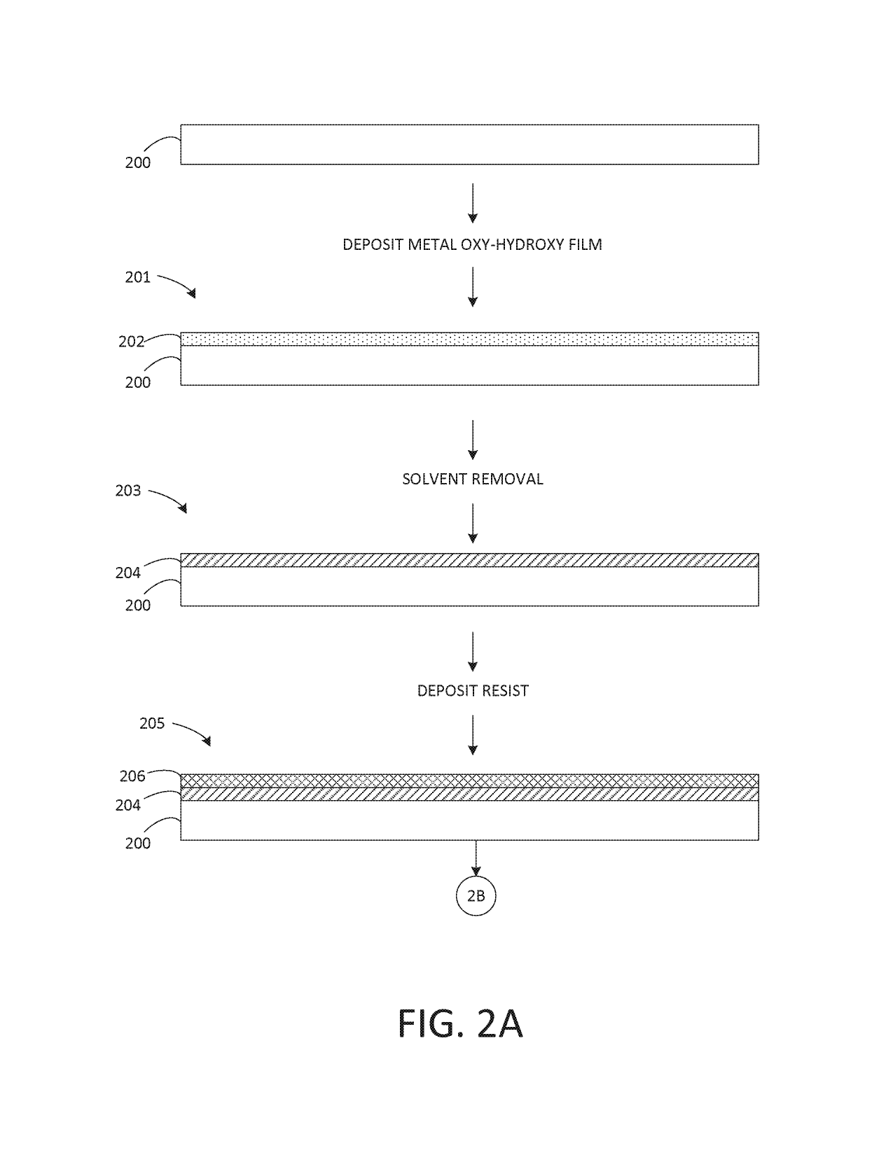

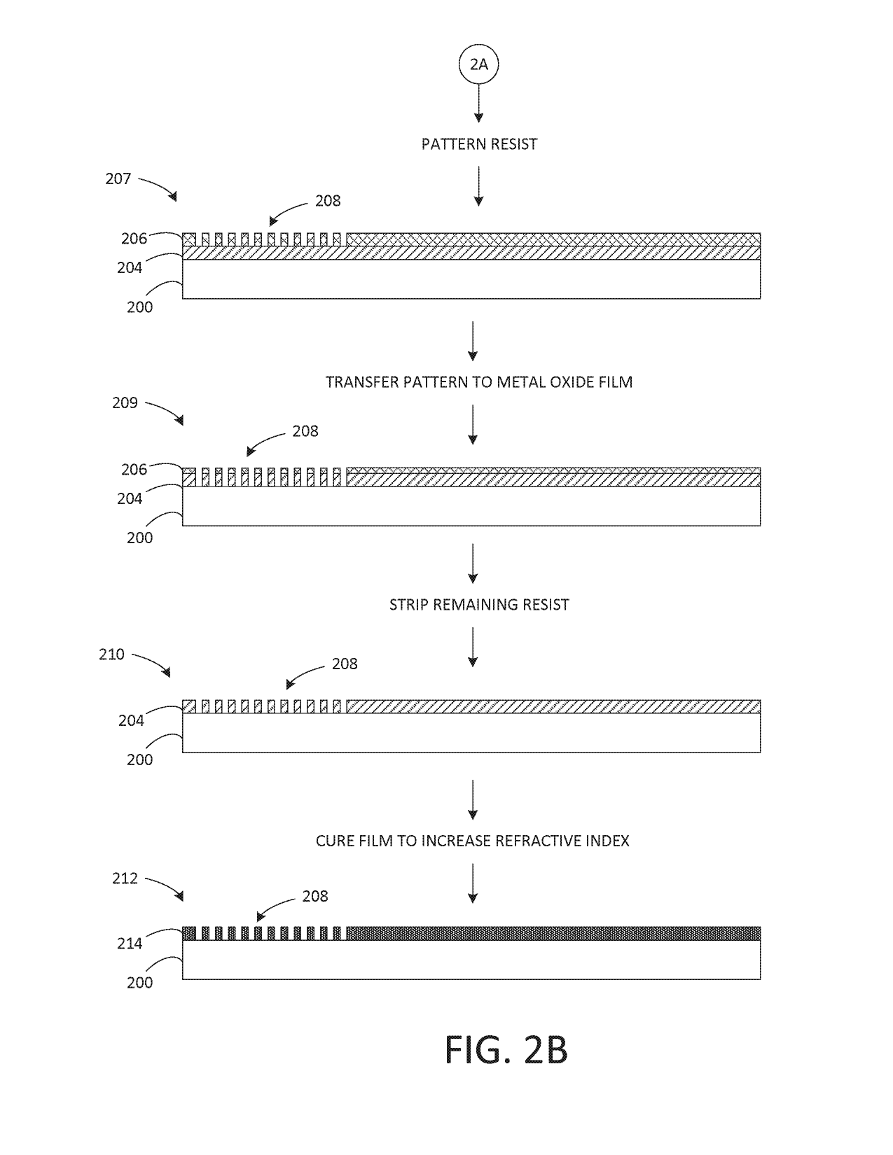

FIGS. 1A-1B show a flow diagram illustrating an example method 100 of forming a metal oxide grating on a substrate such as a waveguide. FIGS. 2A-2B schematically illustrate example structures that can be formed in an implementation of method 100. Method 100 comprises, at 102, applying a precursor solution onto a substrate, the precursor solution comprising a metal-ligand complex, to form a precursor solution film. The substrate can be any suitable material for supporting an optical grating. Example substrates include high index polymers, high index glass, silicon carbide (SiC), lithium niobate (LiNbO₃), and other materials with a refractive index of 1.9 or greater, as indicated at 104. In other examples, a substrate having a refractive index less than 1.9 can be used.

FIG. 2A shows an example substrate at 200, and at 201, substrate 200 after a metal oxide precursor solution has been deposited to form a metal oxide precursor solution film 202. In some examples, the substrate can be a waveguide for an optical device. In such examples, the grating can be incoupler for the waveguide for steering and incoupling light into the waveguide, an outcoupler for steering and outcoupling light out of the waveguide, and/or a conditioner for a waveguide, such as for exit pupil replication and power uniformity Other example uses for a grating include one or more of a lens, a prism, an optical coating, a light extraction layer for a display, a dichroic beam splitter, an anti-reflective layer, or a cold mirror.

The substrate generally presents a surface onto which the metal oxide precursor solution film can be deposited. In some examples, the substrate surface can be treated to prepare the surface for adhesion of the coating material. Also, the surface can be cleaned and/or smoothed as appropriate.

Any suitable coating process can be used to deposit the metal oxide precursor solution on a substrate to form a precursor solution film. Suitable coating processes can include, for example, spin coating, spray coating, dip coating, slot-die coating, knife-edge coating, printing approaches, such as inkjet printing and screen printing, and the like. Some coating approaches form patterns of precursor solution material during the coating process. However, the resolution available currently from printing or the like is lower than the resolution achievable radiation based patterning as described herein. In some examples, the precursor solution can be applied in multiple coating steps to provide greater control over the coating process. For example, multiple spin coatings can be performed to yield an ultimate coating thickness desired. The heat and blanket radiation curing described below can be applied after each coating step, after a plurality of coating steps, or after a final lithographic patterning step, in various examples.

Where patterning of a metal oxide film is to be performed using radiation, spin coating can be an efficient approach to cover the substrate with precursor solution relatively uniformly, although there can be edge effects. In some examples, a substrate can be spun at a rate within a range of 500 rotations per minute (rpm) to 10,000 rpm. In further examples, the substrate can be spun at a rate within a range of 1000 rpm to 7500. In still further examples, the substrate can be spun at a rate within a range of 2000 rpm to about 6000 rpm. The spinning speed can be adjusted to obtain a desired coating thickness and uniformity for the metal oxide precursor film. In some examples, the spin coating can be performed for times from about 5 seconds to about 5 minutes, and in further examples from about 15 seconds to about 2 minutes. In other examples, the spin coating can be performed for a time outside of these ranges. In some examples, an initial low speed spin, e.g. at 50 rpm to 250 rpm, can be used to perform an initial bulk spreading of the precursor solution across the substrate. A back side rinse, edge bead removal step or the like can be performed with water or other suitable solvent to remove any edge bead. A person of ordinary skill in the art will recognize that additional ranges of spin coating parameters within the explicit ranges above are contemplated and are within the scope of the present disclosure.

The precursor solution is an aqueous solution, and can have any suitable metal-ligand complex. Example metals that can be included in ion form in the precursor solution include aluminum, gallium, bismuth, scandium, copper, vanadium, chromium, manganese, iron, cobalt, nickel, zinc, niobium, molybdenum, indium, tin, antimony, hafnium, tantalum, tungsten, iridium, platinum, lanthanum, cerium, praseodymium, neodymium, promethium, samarium, europium, gadolinium, terbium, dysprosium, holmium, erbium, thulium, ytterbium, lutetium, or a combination of two or more thereof, as indicated at 106. Examples of suitable ligands include peroxides (e.g. hydrogen peroxide), nitrates, formic acid, organic ligands, or a combination of two or more thereof. Ligands that lack carbon can provide the advantage of not requiring an oxidative heating process to remove the carbon, and thereby can help to enable a lower temperature process. that would otherwise have to be removed from the film by oxidation. However, organic ligands comprising carbon can be used in some examples. The precursor solution further can comprise an acid. Example acids include hydrochloric acid and nitric acid. Example precursor solutions are disclosed in U.S. Patent Application Serial No. 189/327,766, filed June 1, 2023 and titled METAL OXIDE FILMS AND UV-CURABLE PRECUROR FOR DEPOSITION OF METAL OXIDE FILMS, and U.S. Patent Application Serial No. 28/783,162, filed July 24, 2024 and titled UV-CURABLE PRECURSOR SOLUTIONS FOR DEPOSITION OF MIXED METAL OXIDE FILMS CONTAINING TITANIUM, AND OPTICAL ELEMENTS FORMED BY LIQUID PHASE DEPOSITION OF METAL OXIDE FILMS, the disclosures of each of which are incorporated by reference.

Continuing, method 100 further comprises removing at least some solvent (and potentially some ligand) from the precursor solution film to form a metal oxy-hydroxy film with a first refractive index, at 108. FIG. 2C shows, at 203, substrate 200 after the precursor solution film has had at least some solvent removed, forming a metal oxy-hydroxy film 204. In some examples, the precursor solution coating process itself can result in the evaporation of a portion of the solvent of the precursor solution. This is for at least the reason that many coating processes form droplets or other forms of the coating material with larger surface areas and/or movement of the solution that stimulates evaporation. The loss of solvent tends to increase the viscosity of the metal oxy-hydroxy film as the concentration of the metal oxy-hydroxy species in the mixture increases. Removal of at least some of the solvent helps to stabilize the metal oxy-hydroxy film for further processing.

Further, in some examples, the precursor solution film can be heated prior to patterning and curing to further drive off solvent. Such heating can be performed at temperatures of between 50 and 350 °C in some examples. Temperatures within this range can be compatible with many substrate materials, and can help to achieve a relatively lower dry etch rate for the metal oxide film compared to a metal oxide film that is heated to higher temperatures. However, in other examples, temperatures outside of this range can be used. The resulting dried metal oxy-hydroxy film may generally form a polymeric metal oxo/hydroxo network based on the oxy and hydroxy ligands to the metals (in which the metals optionally may have some organic ligands), or a molecular solid comprised of polynuclear metal oxo/hydroxo species (optionally with organic ligands).

Thicknesses of the precursor solution film and resulting metal oxy-hydroxy film generally can be a function of the precursor solution concentration, viscosity and the spin speed for spin coating. For other coating processes, the thickness can generally also be adjusted through the selection of the coating parameters. In some examples, a thin precursor solution film can be used to facilitate formation of small and highly resolved features in the subsequent patterning process. For example, the precursor solution film can be deposited to result in a metal oxy-hydroxy film, after drying but before curing, with an average thickness of 10 microns or less. In some such examples, the precursor solution film can be deposited to result in a metal oxy-hydroxy film, after drying but before curing, with a thickness of 1 micron or less. In further examples, the precursor solution film can be deposited to result in a metal oxy-hydroxy film, after drying but before curing, with a thickness of 300 nanometers (nm) or less. In other examples, the precursor solution film can be deposited to result in a metal oxy-hydroxy film having a thickness outside of these ranges after drying but before curing. The thickness can be evaluated using the non-contact method ellipsometry based on the optical properties of the film.

The thickness of the metal oxy-hydroxy film after drying can be relatively uniform to facilitate processing. In some embodiments, the variation in thickness of the metal oxy-hydroxy film varies by no more than ±50% from the average coating thickness. In further examples, a thickness of the metal oxy-hydroxy film varies by no more than ±40%. In and in additional examples, a thickness of the metal oxy-hydroxy film varies by no more than about 25% relative to the average coating thickness. The uniformity of come coatings, such as high uniformity coatings on larger substrates, may be evaluated with a 1 centimeter edge exclusion. In other words, the coating uniformity is not evaluated for portions of the coating within 1 centimeter of the edge. In other examples, a different edge exclusion can be used, or no edge exclusion can be used.

As mentioned above, the metal oxy-hydroxy film, after drying but before curing, can have a first refractive index that is relatively lower than a second refractive index achieved by curing. In some examples, the first refractive index can have a value within a range of 1.30 to 2.35, as indicated at 110.

Continuing, method 100 comprises forming a patterned mask layer on the metal oxy-hydroxy film, at 112, and transferring a pattern of the patterned mask layer to the metal oxy-hydroxy film by dry etching to form a patterned metal oxy-hydroxy film, at 118. Due to the relatively high etch rate of the metal oxy-hydroxy film after drying but before curing, a resist layer may be used as a patterned mask layer for reactive ion etching, as opposed to a hardmask. This allows a separate hardmask patterning process to be avoided. As such, method 100 can comprise, at 114, depositing resist and pattern the resist using a mask or maskless photolithography.

FIG. 2A shows, at 205, a resist layer 206 over the metal oxy-hydroxy film 204, and FIG. 2B shows, at 207, the resist layer 206 after patterning the resist layer 206 to form a grating pattern 208. Example resists include conventional organic photoresists such as positive or negative tone resists, chemically amplified resists, diazonaphthoquinone (DNQ)–novolac resists, poly(methyl methacrylate) (PMMA), polyimide-based resists, SU-8, poly(hydroxystyrene)-based resists, epoxy-based resists, organic resists, inorganic resists, hybrid organic–inorganic resists, extreme-ultraviolet (EUV) resists, and the like. Radiation generally can be directed to the resist on the coating through a mask, and interference pattern, or a radiation beam that can be controllably scanned across the substrate. In general, the radiation can comprise electromagnetic radiation, an electron beam (beta radiation), or other suitable radiation. In general, electromagnetic radiation can have a desired wavelength or range of wavelengths, such as visible radiation, ultraviolet radiation or x-ray radiation. When using masks, the resolution achievable for the radiation pattern is generally dependent on the radiation wavelength, and a higher resolution pattern generally can be achieved with shorter wavelength radiation. Thus, it can be desirable to use ultraviolet light, x-ray radiation or an electron beam to achieve particularly high resolution patterns. In interference lithography, light interference via cross beams or the Displacement Talbot method enables the fabrication of features much smaller than the wavelength of light.

In other examples, the pattern can be imprinted into the resist film, as indicated at 116. Further, in other examples, a hardmask can be deposited and patterned (e.g. using a separate photolithography step, as described above) to form the patterned mask.

In further examples, a grayscale lithography process can be used to pattern the resist film, as indicated at 117. In a grayscale lithography process, a radiation-sensitive resist layer is deposited directly onto a metal oxide film. The resist may be a positive-tone or negative-tone resist capable of grayscale exposure. The resist is applied by spin coating or any other methods to achieve a substantially uniform initial thickness, typically in the range of 50 nm to 10 µm, depending on the desired topographic modulation. Following deposition, the resist layer is subjected to an optional soft bake at a temperature sufficient to remove residual solvent and stabilize the resist film. The resist layer then is exposed to patterned radiation using a grayscale photomask or a variable-dose direct-write exposure system. The exposure dose varies spatially across the substrate, such that different regions of the resist receive different effective exposure intensities. As a result, the latent image formed in the resist corresponds to a continuous or multi-level exposure profile rather than a binary or slanted pattern. The exposed resist is developed using a suitable developer solution. Due to the spatially varying exposure dose, the development process produces a resist layer with a spatially varying remaining thickness, thereby forming a three-dimensional resist relief pattern on top of the metal-oxide thin film. The resulting resist profile may include continuous slopes, stepped thickness levels, or arbitrary surface topographies defined by the grayscale exposure pattern. The three-dimensional resist relief pattern is transferred into the underlying metal-oxide thin film by an etching process. The etching may be performed using dry etching, wet chemical etching, or a combination thereof, where the resist serves as a variable-thickness etch mask. During etching, regions of thinner resist are removed more rapidly than regions of thicker resist, thereby producing a corresponding spatial variation in the thickness or surface profile of the metal-oxide thin film. After completion of the etching process, the remaining resist is removed using an appropriate stripping process including etching or dipping in a suitable formulation that dissolves organic or inorganic resists, leaving behind a patterned metal-oxide thin film on the substrate with a grayscale-defined surface topography or thickness distribution.

FIG. 2B further shows, at 209, the metal oxy-hydroxy film 104 after the grating pattern 208 has been transferred by etching. Example etch rates for etching of a metal oxy-hydroxy film comprising one or more of zirconium oxide, titanium oxide, niobium oxide, and tantalum oxide using reactive ion etching and a halogen-based RIE etching chemistry (e.g. utilizing a hydrofluorocabon or fluorocarbon etchant, potentially along with an inert gas such as argon) may be between 70 and 500 nanometers/minute (nm/min), as indicated at 120. The etch rate for the metal oxy-hydroxy film, after drying but before curing, can depend upon etching conditions and also depending upon a density and composition of the metal oxy-hydroxy film. However, as mentioned above, the relatively fast etch rates for the metal oxy-hydroxy film before curing can allow pattern transfer to be performed without fully eroding a resist layer 206 used as a mask. In comparison, the etch rate of a similar ALD metal oxide film layer may be on the order of 20-30 nm/min due to the higher density of ALD metal oxide films. Likewise, the etch rate of a SiC substrate may be on the order of 10-20 nm/min. RIE conditions, such as source power and substrate bias power, can be selected to provide suitably high fidelity pattern transfer. An RIE process can use capacitively coupled power or inductively coupled power, typically in the radiofrequency range.

After pattern transfer, the remaining resist may be removed using oxygen plasma, ashing, solvent stripping, or other suitable method, leaving behind a patterned metal oxy-hydroxy o film. At 210, FIG. 2B shows substrate 200 and patterned metal oxy-hydroxy film 202 with grating pattern 208 after remaining resist layer 206 has been removed. The resulting grating structures may exhibit suitably high resolution, smooth sidewalls, uniform thickness, and suitable optical or electronic properties.

Then, the patterned metal oxy-hydroxy film can be exposed to one or more of ultraviolet light or heat to in a curing process to form a patterned metal oxide film. Curing increases the refractive index of the patterned metal oxide film relative to the patterned metal oxy-hydroxy film to have a second refractive index that is closer to a refractive index of the substrate than the first refractive index, as indicated at 122. The increase in refractive index can be caused by densification during curing by the heat and/or UV exposure (e.g. by polymerization and/or additional solvent and/or ligand removal). FIG. 2B shows, at 212 the metal oxide film after curing at 214. Curing can be performed at temperatures of 600 °C or lower in some examples, and 450 °C or lower in some more specific examples. Compared to sol gel methods that utilize much higher temperatures, the relatively low curing temperatures of the disclosed examples can allow the disclosed grating patterning methods to be used with a variety of substrates that may intolerant to higher temperature processing. The second refractive index can be tuned to have any suitable value. In some examples, the second refractive index has a value of 2.0 – 2.6, as indicated at 124. In some such examples, the second refractive index has a value greater than 2.6. The metal oxide film composition and curing process can be selected to provide a second refractive index having a value within +/- 0.4 of the refractive index of the substrate in some examples, thereby sufficiently matching the index of the substrate to avoid perceptible reflections.

In examples where heating is used in a curing process, solvent removal by the heating may or may not be quantitatively controlled with respect to specific amounts of solvent remaining in the coating material. However, empirical evaluation of the resulting coating material properties generally can be performed to select processing conditions that are effective for the patterning process. In examples in which heat is applied, the coating material can be heated to temperatures from about 45° C to about 250° C. and in further examples from about 55° C to about 225° C. The heating can generally be performed for at least about 0.1 minute, in further examples from about 0.5 minutes to about 30 minutes and in additional examples from about 0.75 minutes to about 10 minutes. A person of ordinary skill in the art will recognize that additional ranges of heating temperature and times within the explicit ranges above are contemplated and are within the scope of the present disclosure. As a result of the heat treatment and densification of the coating material, the coating material can exhibit an increase in refractive index.

In examples in which UV exposure is applied in a curing process, the coating material can be exposed to UV radiation having an intensity from about 1 mW/cm² to about 500 mW/cm² and in further examples from about 50 mW/cm² to about 300 mW/cm². The UV light can have a wavelength within a range of about 193 to about 405 nm in some examples. UV exposure can generally be performed for at least about 1 second, in further examples from about 0.5 minutes to about 60 minutes, and in additional examples from about 1 minute to about 30 minutes. In further examples, UV intensities and/or exposure times outside of the ranges above can be used. As a result of the UV exposure and resulting photochemical densification of the coating material, the coating material can exhibit an increase in refractive index, which can be tuned to match the refractive index of the substrate (e.g. within +/- 0.4 of the refractive index of the substrate). The refractive index further can be tuned by selection of the metal ions used in the metal oxide film. Example metal ions include ions of the metals listed above for the metal-ligand complex. In some more specific examples, the metal oxide film can comprise one or more of titanium dioxide (TiO₂), zirconium dioxide (ZrO₂), niobium oxide (Nb₂O₅), or hafnium oxide (HfO₂).

The resulting waveguide comprises a substrate configured to support propagation of light within the substrate by total internal reflection, and the optical grating formed as describe above. While the examples of FIGS. 1A-1B and 2A-2B describe and illustrate the formation of a single grating on a substrate, in other examples a substrate may comprise more than one grating. For example, an augmented reality display device may utilize a see-through waveguide for combining virtual imagery with a real-world background. Such a waveguide may include gratings for steering and coupling light into and/or out of the substrate, and/or for expanding an exit pupil of the optical system, as examples. As described above, in some examples, the substrate comprises a material having a refractive index of 1.9 or greater. Example materials include high index polymers, high index glass, silicon carbide (SiC), and lithium niobate (LiNbO₃). Alternatively or additionally, in some examples, the metal oxide comprises one or more of titanium dioxide (TiO₂), zirconium dioxide (ZrO₂), niobium oxide (Nb₂O₅), or hafnium oxide (HfO₂). Alternatively or additionally, in some examples, a refractive index of the metal oxide is within 0.4 of a refractive index of the substrate. This helps to avoid perceptible light reflections from the grating/substrate interface.

The grating formed on the substrate can have any suitable pattern. In various examples, the grating can comprise one or more of a blazed grating pattern, a binary grating pattern, a slanted grating pattern, or a gray scale pattern.

In some examples, wherein the metal oxide of the grating has an optical transmission of 90% or greater in the visible spectrum. Alternatively or additionally, in some examples, the metal oxide comprises a refractive index of 2.0 or greater. Alternatively or additionally, in some examples, the optical grating comprises a line-to-space ratio within a range of 1:1 to 1:3 (line width:space width). Alternatively or additionally, in some examples, the metal oxide exhibits a haze of less than 0.1%.

The example waveguides comprising substrates with metal oxide gratings described herein may be used in any suitable device. Examples include titanium-containing oxides as light extraction layers in OLED displays, optical waveguides, optical claddings, dichroic beam splitters, light diffusers, anti-reflective layers, cold mirrors, hot mirrors, and other optical components.

### EXPERIMENTAL

In experiments, the refractive index of the thin films was adjusted by systematically modulating the composition of precursors, reagent concentrations, solvent selection, and reaction conditions. A design of experiments methodology was implemented to ensure that the resulting films exhibited high transparency and were substantially free of optical haze. The precursor formulations were specifically engineered to be nanoparticle-free, thereby maintaining low viscosities, with viscosities measured as low as 1.5 centipoise (cP).

Silicon wafers were used as substrates. Prior to deposition, the substrate surfaces were subjected to a cleaning process using a Plasma Etch PE-50 system to ensure optimal adhesion. Film deposition was carried out by spin-coating the precursor solution onto silicon substrates at a rotation speed of 3000 rpm for a duration of 30 seconds. The films were then subjected to an initial UV curing process at a wavelength of 365 nm, with a cure dose of approximately 5 J/cm². Subsequent thermal curing was performed in a Neytech Qex furnace for a duration of approximately 5 to 15 minutes, depending on the specific curing requirements of the film.

Characterization of the film thickness and refractive index was conducted using a J.A. Woollam M-2000 spectroscopic ellipsometer. The collected data were analyzed and modeled using the CompleteEASE software package, incorporating the presence of a thin SiO₂ substrate layer in all models. Transmission measurements were performed utilizing an Avantes AVASPEC-3648 system. Haze measurements were carried out at a wavelength of 520 nm using a total integrated scattering (TIS) methodology. The haze metrology system, equipped with an integrating sphere, served to validate the reflection and transmission modeling derived from spectroscopic ellipsometry data.

Scanning electron microscopy (SEM) was performed using an FEI Helios NanoLab 650 dual beam SEM/focused ion beam system. SEM imaging was conducted on uncoated samples using the through-the-lens detector in immersion mode, operating at an accelerating voltage of 15 kV. These procedures collectively demonstrated the suitability of the films for high-performance optical applications, with precise control over their properties.

### Preparation of a high refractive index film

A precursor solution comprising a titanium-ligand complex was prepared according to the procedure described in the above-referenced U.S. Patent Application Publication No. US Patent Application Serial No. 18,327,766. The precursor solution comprised 3 mL of TiCl₃•3HCl (aq) (30%) mixed with 1 mL of H₂O₂(aq) (30%).

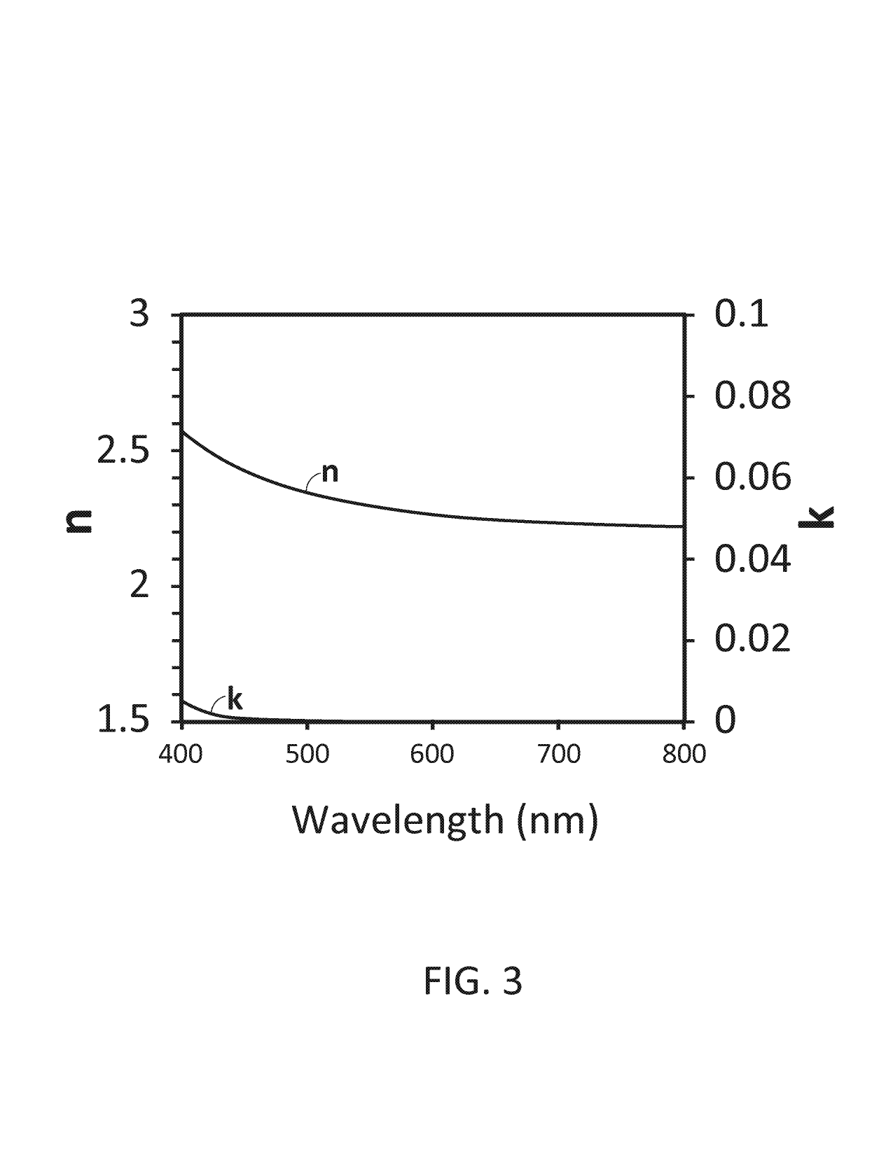

The precursor was spin coated onto a glass substrate and cured at 250°C for 15 minutes after ion extraction step to form a high refractive index film. The film had a refractive index of 2.30 at a wavelength of 520 nm. FIG. 3 shows a dispersion curve of this film cured at 250 ºC for 15 minutes. As shown, the film demonstrates no absorption (k = 0).

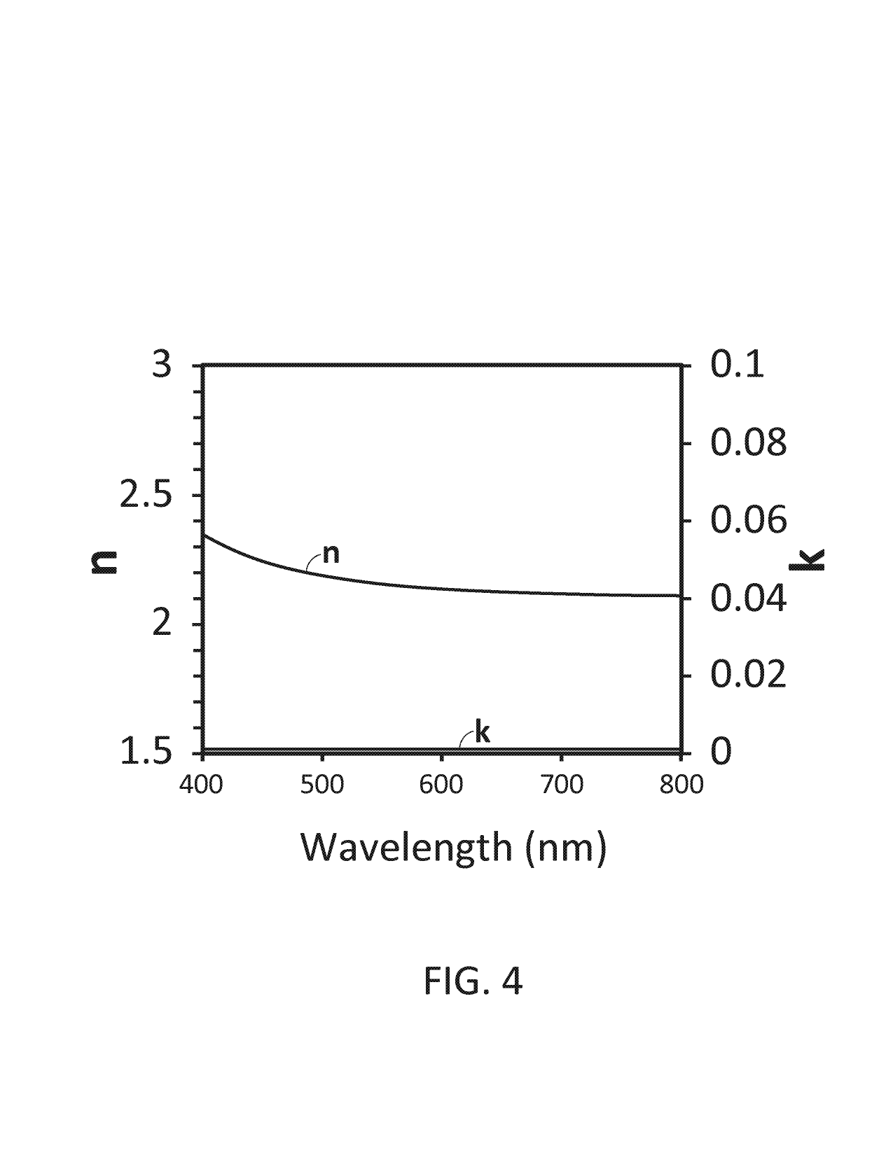

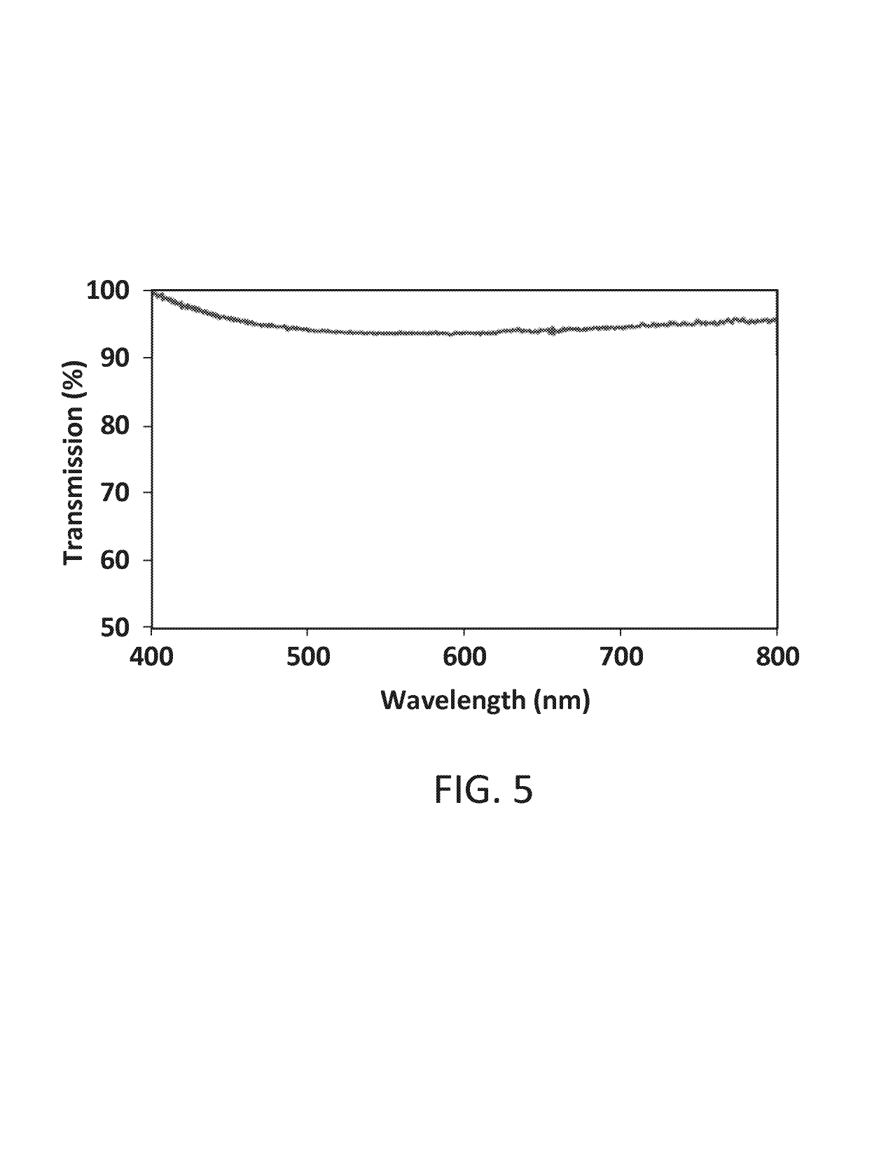

As mentioned above, the refractive index of the metal oxide can be tuned by controlling curing conditions. For example, FIG. 4 shows a dispersion curve of a UV-cured metal oxide film of the same composition as that of FIG. 3, cured using a 100 ºC bake for 15 minutes, demonstrating a refractive index of 2.16 at λ = 550 nm, with no absorption (k = 0). FIG. 5 shows an optical transmission spectrum of a ~100 nm thick film of the same composition of the film of FIGS. 3 and 4, with refractive index n = 2.30 and deposited on high refractive index glass, This film demonstrated over 90% transmission and minimal absorption.

### Application of a high refractive index film to an optical device

A method for fabricating patterned metal oxide films using a BARC (Bottom Anti-Reflective Coating) layer, displacement Talbot lithography (DTL), and reactive ion etching (RIE) is described as follows. Initially, a metal oxide film with high refractive index film was prepared according to Example 1. The surface of the cured metal oxide film was then prepared for further processing by applying a BARC layer. The BARC layer was deposited using spin coating to achieve a uniform thickness, optimized for minimizing reflections during subsequent photolithography steps. The coated substrate was then soft-baked at an appropriate temperature, typically between 80°C and 120°C, to remove solvents and stabilize the BARC layer.

Next, a photoresist (PR) layer was applied onto the BARC-coated surface. The PR was spin-coated at a controlled speed to achieve the desired thickness, followed by a soft-bake step to prepare the PR for exposure. The patterned features were defined in the PR using displacement Talbot lithography (DTL), a high-resolution, maskless lithographic technique that enables precise and scalable patterning. The PR-coated substrate was exposed to the interference pattern generated by the DTL system under controlled conditions of wavelength, intensity, and exposure time. After exposure, the PR was developed using an appropriate developer solution, revealing the patterned features.

The patterned PR served as a mask for subsequent etching processes. The substrate was transferred to a reactive ion etching (RIE) system for pattern transfer into the underlying layers. Initially, the BARC layer was etched using a fluorine-based plasma to expose the metal oxide film while preserving the PR pattern. Following this, the metal oxide film was etched using CHF₃ and/or SF₆ or a combination of gases in the RIE system. The etching parameters, including gas flow rates, chamber pressure, RF power, and etch time, were optimized to achieve anisotropic etching and high fidelity of the transferred patterns.

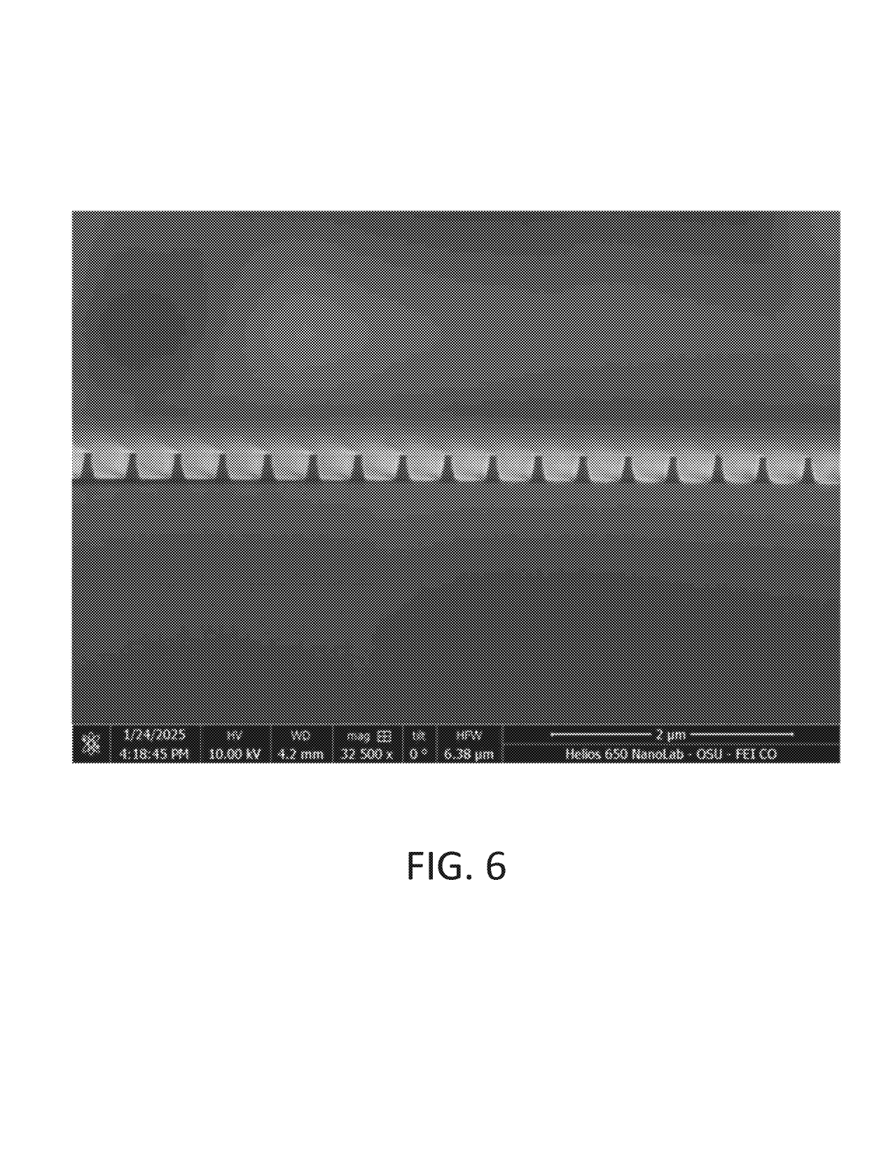

Once the etching process was complete, the remaining PR and BARC layers were removed using an oxygen plasma or an appropriate solvent, leaving behind the patterned metal oxide film. The resulting structures exhibit high resolution, uniformity, and smooth sidewalls, making them suitable for advanced optical and electronic applications. FIG. 6 shows a scanning electron microscopy (SEM) image of a grating structure fabricated from a metal oxide film, demonstrating well-defined features with high uniformity and smooth sidewalls.

Metal oxide films as disclosed herein may be used in any suitable device. As one example, a titanium-containing oxide film as disclosed herein may be used as a light extraction layer in an organic light-emitting diode (OLED) display panel. The disclosed titanium containing oxide films also may be used as other waveguides, as optical claddings, and in optical components such as dichroic beam splitters, light diffuser, anti-reflective layers, cold mirrors, and hot mirrors.

Further, the disclosure comprises configurations according to the following examples.

Example 1. A method of fabricating an optical grating, the method comprising: applying a precursor solution onto a substrate, the precursor solution comprising a metal-ligand complex to form a precursor solution film; removing at least some solvent from the precursor solution film to form a metal oxy-hydroxy film with a first refractive index; forming a patterned mask layer on the metal oxy-hydroxy film; transferring a pattern of the patterned mask layer to the metal oxy-hydroxy film by dry etching to form a patterned metal oxy-hydroxy film; and exposing the patterned metal oxide film to one or more of ultraviolet light or heat to form a patterned metal oxide film with a second refractive index that is closer to a refractive index of the substrate than the first refractive index.

Example 2. The method of Example 1, wherein forming the patterned mask layer comprises depositing a radiation-sensitive resist layer and patterning the resist layer using a photomask, maskless lithography, or grayscale lithography.

Example 3. The method of Examples 1 or 2, wherein forming the patterned mask layer comprises imprinting the pattern.

Example 4. The method of any of Examples 1-3, wherein dry etching the metal oxy-hydroxy film comprises etching the metal oxy-hydroxy film at an etch rate within a range of 70-500 nanometers/minute.

Example 5. The method of any of Examples 1-4, wherein the substrate comprises a material having a refractive index of 1.9 or greater.

Example 6. The method of any of Examples 1-5, wherein the first refractive index is within a range of 1.30 to 2.35.

Example 7. The method of any of Examples 1-6, wherein the second refractive index is 2.0 or greater.

Example 8. The method of any of Examples 1-7, wherein the metal of the metal-ligand complex comprises aluminum, gallium, bismuth, scandium, copper, vanadium, chromium, manganese, iron, cobalt, nickel, zinc, niobium, molybdenum, indium, tin, antimony, hafnium, tantalum, tungsten, iridium, platinum, lanthanum, cerium, praseodymium, neodymium, promethium, samarium, europium, gadolinium, terbium, dysprosium, holmium, erbium, thulium, ytterbium, lutetium, or a combination of two or more thereof.

Example 9. The method of any of Examples 1-8, wherein the metal oxide comprises one or more of titanium dioxide (TiO₂), zirconium dioxide (ZrO₂), niobium oxide (Nb₂O₅), or hafnium oxide (HfO₂).

Example 10. An optical waveguide, comprising a substrate configured to support propagation of light within the substrate by total internal reflection; and one or more optical gratings comprising a metal oxide deposited on a side of the substrate, the one or more optical gratings configured to steer and couple light into and/or out of the substrate.

Example 11. The optical waveguide of Example 10, wherein the substrate comprises a material having a refractive index of 1.9 or greater, and the metal oxide comprises one or more of titanium dioxide (TiO₂), zirconium dioxide (ZrO₂), niobium oxide (Nb₂O₅), or hafnium oxide (HfO₂).

Example 12. The optical waveguide of Example 10 or 11, wherein a refractive index of the metal oxide is within 0.4 of a refractive index of the substrate.

Example 13. The optical waveguide of any of Examples 10 – 12, wherein the grating comprises one or more of a blazed grating pattern, a binary grating pattern, or a slanted grating pattern or a gray scale pattern.

Example 14. The optical waveguide of any of Examples 10-13, wherein the metal oxide has an optical transmission of 90% or greater in the visible spectrum.

Example 15. The optical waveguide of any of Examples 10-14, wherein the metal oxide comprises a refractive index of 2.0 or greater.

Example 16. The optical waveguide of any of Examples 10-15, wherein the optical grating comprises a line-to-space ratio within a range of 1:1 to 1:3 (line width:space width).

Example 17. The optical waveguide of any of Examples 10-16, wherein the metal oxide exhibits a haze of less than 0.1%.

Example 18. An optical waveguide comprising a substrate configured to support propagation of light within the substrate through total internal reflection; and an optical grating comprising a metal oxide deposited on a side of the inorganic substrate, the optical grating configured to couple light into and/or out of the substrate, the metal oxide having a refractive index of 2.0 or greater, an optical transmission of 90% or greater in the visible spectrum, and exhibits a haze of less than 0.1%.

Example 19. The optical waveguide of Example 18, wherein the optical grating is incorporated into the optical device as one or more of an incoupler for a waveguide, an outcoupler for a waveguide, a lens, a prism, an optical coating, a light extraction layer for a display, a dichroic beam splitter, an anti-reflective layer, or a cold mirror.

Example 20. The optical waveguide of Examples 18 or 19, wherein the metal oxide comprises one or more of titanium dioxide (TiO₂), zirconium dioxide (ZrO₂), niobium oxide (Nb₂O₅), or hafnium oxide (HfO₂).

It will be understood that the configurations and methods described herein are provided by way of example, and that these examples are not to be considered in a limiting sense because numerous variations, extensions, and omissions are also envisaged. Any of the various acts of an above method may be performed in the sequence illustrated, in other sequences, in parallel, or omitted. The subject matter of the present disclosure includes all novel and nonobvious combinations and sub-combinations of the various configurations, methods, properties, and other features disclosed herein, as well as any and all equivalents thereof.

1. A method of fabricating an optical grating, the method comprising:
applying a precursor solution onto a substrate, the precursor solution comprising a metal-ligand complex to form a precursor solution film;
removing at least some solvent from the precursor solution film to form a metal oxy-hydroxy film with a first refractive index;
forming a patterned mask layer on the metal oxy-hydroxy film;
transferring a pattern of the patterned mask layer to the metal oxy-hydroxy film by dry etching to form a patterned metal oxy-hydroxy film; and
exposing the patterned metal oxide film to one or more of ultraviolet light or heat to form a patterned metal oxide film with a second refractive index that is closer to a refractive index of the substrate than the first refractive index.

2. The method of claim 1, wherein forming the patterned mask layer comprises depositing a radiation-sensitive resist layer and patterning the radiation-sensitive resist layer using a photomask, maskless lithography, or grayscale lithography.

3. The method of claim 1, wherein forming the patterned mask layer comprises imprinting the pattern.

4. The method of claim 1, wherein dry etching the metal oxy-hydroxy film comprises etching the metal oxy-hydroxy film at an etch rate within a range of 70-500 nanometers/minute.

5. The method of claim 1, wherein the substrate comprises a material having a refractive index of 1.9 or greater.

6. The method of claim 1, wherein the first refractive index is within a range of 1.30 to 2.35.

7. The method of claim 1, wherein the second refractive index is 2.0 or greater.

8. The method of claim 1, wherein the metal of the metal-ligand complex comprises aluminum, gallium, bismuth, scandium, copper, vanadium, chromium, manganese, iron, cobalt, nickel, zinc niobium, molybdenum, indium, tin, antimony, hafnium, tantalum, tungsten, iridium, platinum, lanthanum, cerium, praseodymium, neodymium, promethium, samarium, europium, gadolinium, terbium, dysprosium, holmium, erbium, thulium, ytterbium, lutetium, or a combination of two or more thereof.

9. The method of claim 1, wherein the metal oxide comprises one or more of titanium dioxide (TiO2), zirconium dioxide (ZrO2), niobium oxide (Nb₂Os), or hafnium oxide (HfO₂).

10. An optical waveguide, comprising:
a substrate configured to support propagation of light within the substrate by total internal reflection; and
one or more optical gratings comprising a metal oxide deposited on a side of the substrate, the one or more optical gratings configured to steer and couple light into and/or out of the substrate.

11. The optical waveguide of claim 10, wherein the substrate comprises a material having a refractive index of 1.9 or greater, and the metal oxide comprises one or more of titanium dioxide (TiO2), zirconium dioxide (ZrO2), niobium oxide (Nb₂Os), or hafnium oxide (HfO₂).

12. The optical waveguide of claim 10, wherein a refractive index of the metal oxide is within 0.4 of a refractive index of the substrate.

13. The optical waveguide of claim 10, wherein the grating comprises one or more of a blazed grating pattern, a binary grating pattern, or a slanted grating pattern or a gray scale pattern.

14. The optical waveguide of claim 10, wherein the metal oxide has an optical transmission of 90% or greater in the visible spectrum.

15. The optical waveguide of , wherein the metal oxide comprises a refractive index of 2.0 or greater.

16. The optical waveguide of claim 10, wherein the optical grating comprises a line-to-space ratio within a range of 1:1 to 1:3 (line width:space width).

17. The optical waveguide of claim 10, wherein the metal oxide exhibits a haze of less than 0.1%.

18. An optical waveguide comprising
a substrate configured to support propagation of light within the substrate through total internal reflection; and
an optical grating comprising a metal oxide deposited on a side of the inorganic substrate, the optical grating configured to couple light into and/or out of the substrate, the metal oxide having a refractive index of 2.0 or greater, an optical transmission of 90% or greater in the visible spectrum, and exhibits a haze of less than 0.1%.

19. The optical waveguide of claim 18, wherein the optical grating is incorporated into the optical device as one or more of an incoupler for the optical waveguide, an outcoupler for the optical waveguide, a lens, a prism, an optical coating, a light extraction layer for a display, a dichroic beam splitter, an anti- reflective layer, or a cold mirror.

20. The optical waveguide of claim 18, wherein the metal oxide comprises one or more of titanium dioxide (TiO2), zirconium dioxide (ZrO2), niobium oxide (Nb20s), or hafnium oxide (HfO2).
